(19) United States
(12) Patent Application Publication
(10) Pub. No.: US 2025/0377003 A1
(43) Pub. Date: Dec. 11, 2025

(54) BEARING SUPPORT FOR TELESCOPING MECHANISM SPINDLE

(71) Applicants: Yair Shilo, Kibbutz Shefayim (IL); Amitai David Fried, Givat Shmuel (IL)

(72) Inventors: Yair Shilo, Kibbutz Shefayim (IL); Amitai David Fried, Givat Shmuel (IL)

(73) Assignees: Yair Shilo, Kibbutz Shefayim (IL); Omri Nayshool, Kibbutz Shefayim (IL); Aviv Antebi, Rosh Haayin (IL)

(21) Appl. No.: 18/734,135

(22) Filed: Jun. 5, 2024

(51) Int. Cl. F16B 7/10; A63H 33/00; F16C 35/08

(52) U.S. Cl. CPC F16B 7/10; F16C 35/08; A63H 33/009

(57) ABSTRACT

A telescoping mechanism includes a handle including a motor and a controller operatively connected to the motor for controlling operation of the motor, a spindle operatively coupled to, and configured to be rotated by, the motor. The spindle is not journaled by the motor and instead is journaled by a bearing support distanced from the motor. Telescoping segments are coupled to the spindle. The telescoping segments are nested together in a contracted orientation and extend outwards upon rotation of the spindle.

### FIELD OF THE INVENTION

The present invention relates generally to telescoping mechanisms, and particularly to an improved bearing support for a rotating spindle of a motorized telescoping mechanism.

### BACKGROUND OF THE INVENTION

There are many different kinds of telescoping mechanisms. FIGS. 1A and 1B illustrate portions of a prior art telescoping mechanism shown in U.S. Pat. No. 11,980,827, which is a telescoping mechanism for a toy sword or other telescoping applications.

As seen in FIG. 1A, the prior art telescoping mechanism includes a telescopic segmented hollow sword blade 1, which may have, for example five hollow blade segments 1A, 1B, 1C, 1D, and 1E. The telescopic mechanism effects extension and retraction of the blade segments by means of a motor 2 which rotates a threaded rod or spindle 3 that passes through the longitudinal axis of the blade 1. In the prior art telescoping mechanism, flexible/resilient nuts 4A, 4B, 4C, 4D, and 4E respectively interface at the proximal portion of each hollow blade segment 1A, 1B, 1C, 1D, and 1E.

FIG. 1B shows the prior art telescoping mechanism including a segment holder 5 in the form of a ring, which can be an elastic ring, snap-fit ring or threaded ring, configured to allow segments 1 to be attached to and removed from a handle (not shown here). FIG. 1B shows a lighting element 6, such as one or more LEDs, whose light can shine outward through openings in the toy sword or through one or more transparent or translucent windows.

In operation, the user activates motor 2 (by pressing on an extension actuator button, not shown), which rotates spindle 3. As a result, the first (smallest) nut 4A rises on the spindle 3 to extend/push the first (smallest) segment 1A (which is positioned above a nut/segment brake mechanism 7 seen in FIG. 1B). When segment 1A is fully extended, it pulls on the next largest segment 1B, pulling the next nut 4B over brake mechanism 7, and nut 4B rises on spindle 3 to extend segment 1B, and so on.

As seen in FIG. 1C, spindle 3 is directly coupled to motor 2 via a coupling 8. Accordingly, in this prior art telescoping mechanism, spindle 3 is only journaled (that is, rotationally supported) by bearings located inside motor 2. The lighting element 6 does not provide rotational bearing support for spindle 3 and the far end of spindle 3 (the end furthest from the motor 2) is not supported by any bearings. In such an arrangement, the spindle 3 may be prone to wobbling.

Another prior art telescoping mechanism is shown in FIG. 1D, which illustrates a portion of a prior art telescoping pole saw, shown in U.S. Pat. No. 11,618,149. A telescoping pole saw has a rotatable saw blade disposed at the end of telescoping pole segments. The user can extend the segments so the pole saw can reach high branches that need to be pruned or cut.

The prior art telescoping pole saw includes an inner pole slidably received in an outer pole. The pole assembly is movable between a retracted configuration and an extended configuration. A driveshaft extends longitudinally in the outer pole and the inner pole. The prior art telescoping pole saw has bearings along the length of the entire telescopic shaft to transmit power to the saw. The bearings must move as the pole assembly collapses and extends.

As seen in FIG. 1D, the prior art telescoping pole saw has a bearing assembly 132 that includes a plurality of bearings 134A, 134B, and 134C that are disposed between the driveshaft and the outer pole (not shown here). The bearings 134A, 134B, and 134C maintain the driveshaft in a centered position relative to the outer pole and facilitate rotation of the driveshaft relative to the outer pole. Each bearing has a flat section 140. Each bearing 134A, 134B, and 134C includes a driveshaft passage 136 defined therein, through which the driveshaft extends. A protruding collar 144 is received in a proximal end of the inner pole. Each bearing is connected to an adjacent bearing by three connection members 152.

Although this arrangement of bearings provides wobble free rotation of all the telescoping portions, it is, however, not applicable for use as bearing supports for the rotating threaded spindle of a motorized telescoping mechanism. As stated above, in the prior art telescoping pole saw, the bearings must move as the pole assembly collapses and extends. This is not an acceptable solution for the rotating threaded spindle mechanism, in which the bearings must remain in place.

### SUMMARY OF THE INVENTION

The present invention seeks to provide an improved bearing support for a rotating spindle of a motorized telescoping mechanism, as is described more in detail hereinbelow.

There is thus provided in accordance with an embodiment of the present invention a telescoping mechanism including a handle including a motor and a controller operatively connected to the motor for controlling operation of the motor, a spindle operatively coupled to, and configured to be rotated by, the motor, the spindle not being journaled by the motor and instead being journaled by a bearing support distanced from the motor, and telescoping segments coupled to the spindle, wherein the telescoping segments are nested together in a contracted orientation and extend outwards upon rotation of the spindle.

In accordance with a non-limiting embodiment of the invention, the bearing support is located an axial distance away from an end of a motor shaft of the motor.

In accordance with a non-limiting embodiment of the invention, the bearing support includes a plate formed with a bearing aperture with smooth surfaces to support rotation of the spindle, and sides that extend from the plate.

In accordance with a non-limiting embodiment of the invention, the motor is coupled to the spindle via a gear train.

In accordance with a non-limiting embodiment of the invention, the spindle is further journaled in a bearing located in the handle at an axial distance further away from the motor than the bearing support.

In accordance with a non-limiting embodiment of the invention, the bearing is disposed in a recess formed in a lighting element.

### BRIEF DESCRIPTION OF THE DRAWINGS

The present invention will be understood and appreciated more fully from the following detailed description, taken in conjunction with the drawing in which:

FIGS. 1A, 1B and 1C are pictorial illustrations of portions of a prior art telescoping mechanism shown in U.S. Pat. No. 11,980,827.

FIG. 1D is a pictorial illustration of a portion of a prior art telescoping pole saw shown in U.S. Pat. No. 11,618,149.

FIG. 2A is a simplified partially-sectional illustration of a rotating spindle of a motorized telescoping mechanism with an improved bearing support for the rotating spindle, in accordance with a non-limiting embodiment of the present invention, the telescoping mechanism being shown without nested telescoping segments for simplicity and clarity.

FIGS. 2B, 2C, 2D and 2E are four enlarged views of the improved bearing support.

FIG. 2F is a simplified perspective view corresponding to FIG. 2A.

FIG. 3A is a simplified partially-sectional illustration of the rotating spindle of the motorized telescoping mechanism with the improved bearing support for the rotating spindle, and showing the nested telescoping segments.

FIG. 3B is a simplified perspective view corresponding to FIG. 3A.

### DETAILED DESCRIPTION OF EMBODIMENTS

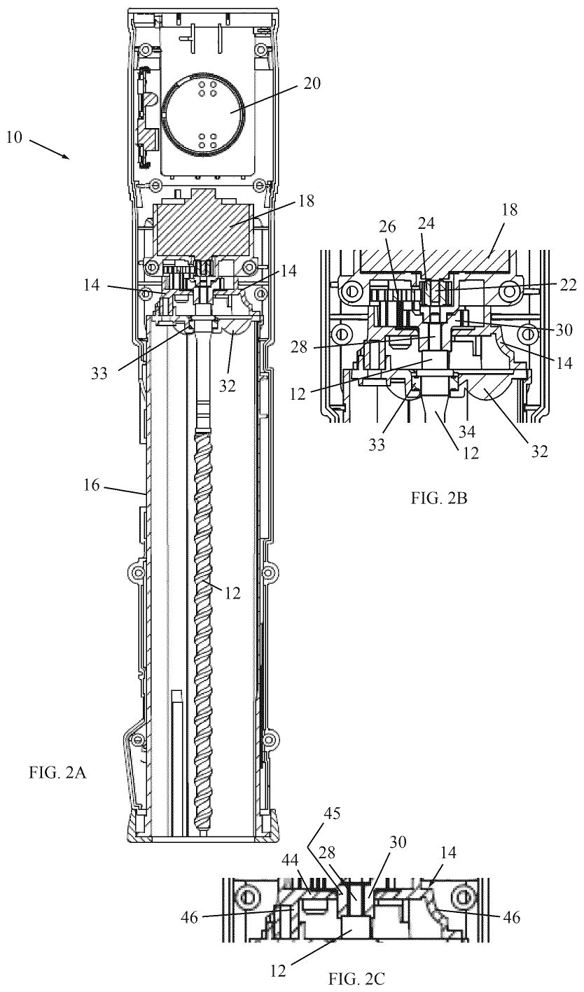

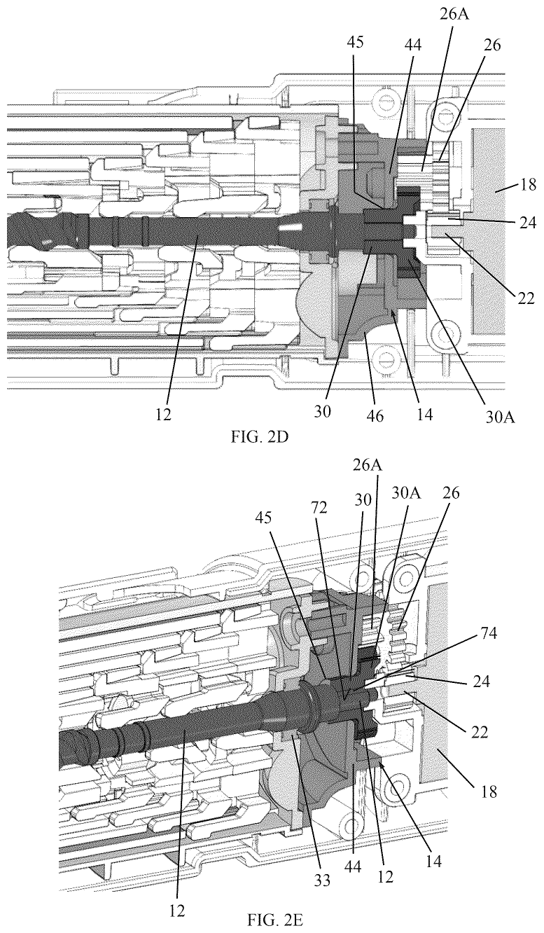

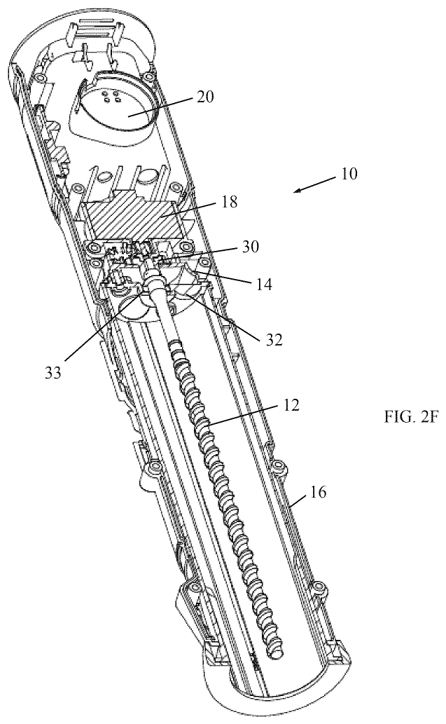

Reference is now made to FIGS. 2A, 2B and 2C, which illustrate a rotating spindle 12 of a motorized telescoping mechanism 10 with a bearing support 14 for the rotating spindle 12, in accordance with a non-limiting embodiment of the present invention.

As seen in FIGS. 2A and 2F, the telescoping mechanism 10 is housed in a handle 16. Handle 16 may include therein a motor 18, which is operated by a controller 20, which may include a battery for energizing the motor, an operating switch and other electrical components.

As seen in FIG. 2B, the motor 18 may have a motor shaft 22 which may be coupled to spindle 12 via a gear train, such as but not limited to, a first spur gear 24 mounted on motor shaft 22 which meshes with a larger, second spur gear 26. Gear 26 may be coupled to a proximal portion 28 of spindle 12 by means of a coupling member 30, a non-limiting example of which is described below.

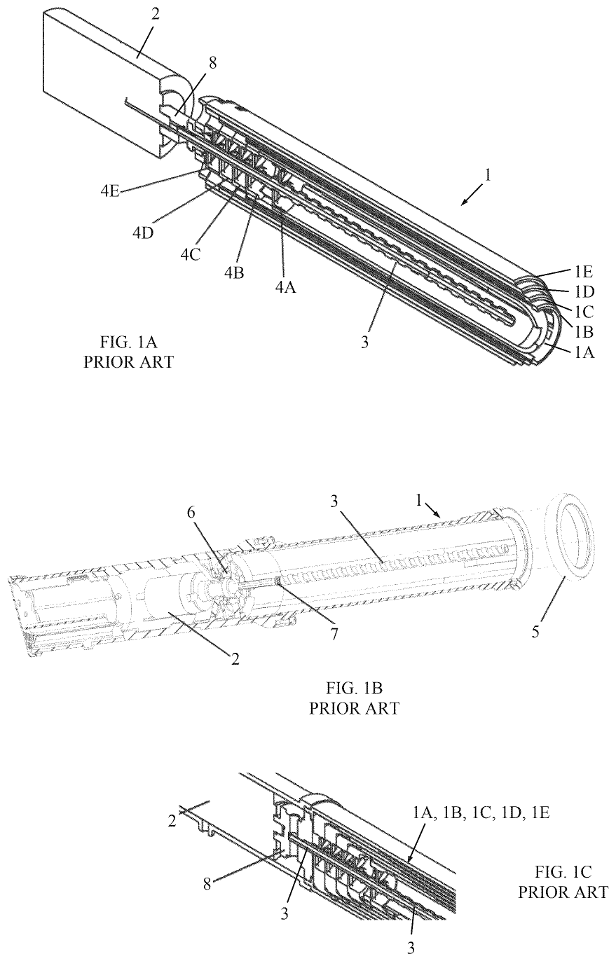

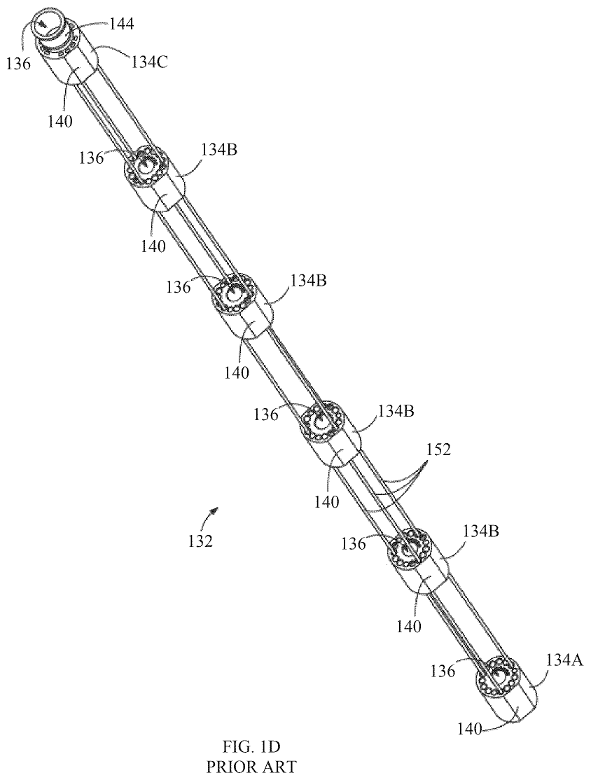

In the present invention, as opposed to the prior art shown in FIGS. 1A and 1B, rotating spindle 12 is journaled (that is, rotationally supported) by bearing support 14 being located an axial distance away from the end of motor shaft 22 of motor 18. As seen best in FIGS. 2C, 2D and 2E, bearing support 14 may include, without limitation, a plate 44 formed with a bearing aperture 45 (with smooth surfaces to support rotation of spindle 12). Sides 46 may extend from plate 44; any one of the sides 46 may be sloping or straight or other shapes.

As seen best in FIGS. 2D and 2E, second spur gear 26 may include a geared hub 26A, which meshes with a gear extension 30A of coupling member 30. Coupling member 30 may be cylindrical and is journaled in bearing aperture 45. Coupling member 30 may be formed with a keyed aperture 72, such as a D-shaped hole that mates with a flat surface 74 (FIG. 2E) formed on spindle 12. Thus, the external cylindrical contour of coupling member 30 is supported in its rotation by bearing support 14 (by means of bearing aperture 45) and transmits torque to rotate spindle 12 by means of the flat surface 74 of spindle being received in keyed aperture 72. Motor 18 transmits torque to coupling member 30 by means of the gear train: gear 24 is rotated directly by shaft 22 of motor 18; gear 24 meshes with gear 26 and gear hub 26 of gear 26 meshes with gear extension 30A of coupling member 30.

Alternatively, bearing support 14 may provide rotational support of spindle 12, and instead spindle 12 has a geared portion that meshes with the gear train. Such a geared portion of spindle 12 replaces coupling member 30.

Alternatively, instead of using the bearing aperture 45, bearing support 14 may include, without limitation, a smooth bushing, a ball bearing (e.g., deep-groove ball bearing, angular contact ball bearing, self-aligning ball bearing, and others), a roller bearing (e.g., tapered, cylindrical, spherical, needle and others), or specialized bearings, such as magnetic bearings and others.

In accordance with a non-limiting embodiment of the invention, another bearing 33, seen best in FIG. 2B, may be used to journal spindle 12. Bearing 33 is located in handle 16 at an axial distance further away from motor 18 than bearing support 14. Bearing 33 may be, without limitation, a ball bearing (e.g., deep-groove ball bearing, angular contact ball bearing, self-aligning ball bearing, and others), a roller bearing (e.g., tapered, cylindrical, spherical, needle and others), or specialized bearings, such as magnetic bearings and others. Alternatively, bearing 33 may be a bearing aperture or bushing with smooth surfaces to support rotation of spindle 12.

It is noted that the invention can be carried out by using both bearing support 14 and bearing 33; alternatively, the invention can be carried out by using just bearing support 14 without bearing 33; and alternatively, the invention can be carried out by using just bearing 33 without the aperture 45 of bearing support 14 providing any rotational support to spindle 12 (in such a case, bearing 33 is the only bearing support and is alternatively called bearing support 33).

The motorized telescoping mechanism 10 may include a lighting element 32, such as one or more LEDs, whose light can shine outward through openings in the toy sword or through one or more transparent or translucent windows. As opposed to the prior art shown in FIG. 1B, in the present invention, bearing 33 may be advantageously disposed in a counterbore or other recess 34 formed in lighting element 32, preferably, but not necessarily, in the center of lighting element 32.

It is noted that in this embodiment of the invention, the spindle 12 does not extend into the motor 18 and is not journaled by the motor 18. Instead, bearing support 14, which is not part of motor 18 and is distanced from motor 18 forms the bearing support for spindle 12. Bearing 33 may be used to increase the bearing support to ensure no wobbling of spindle 12.

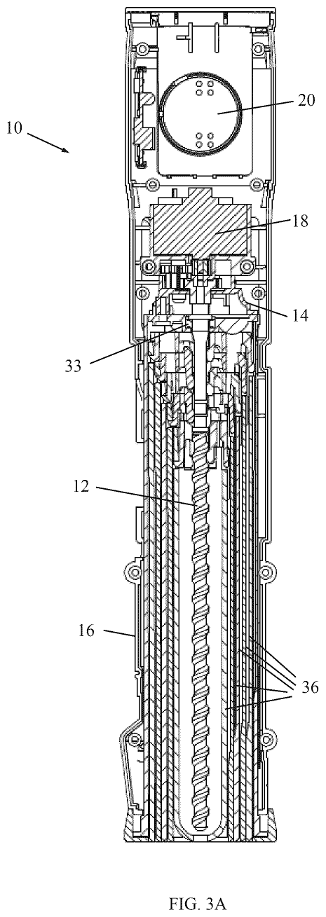

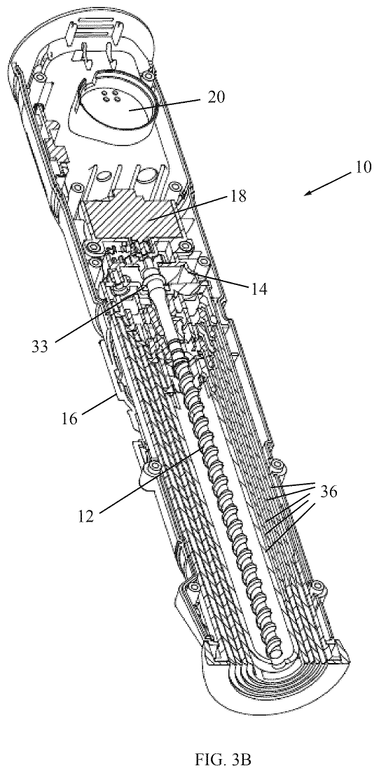

FIGS. 3A and 3B illustrate the rotating spindle 12 of the motorized telescoping mechanism 10 with the improved bearing support 14 and bearing 33, and showing nested telescoping segments 36. The telescoping segments 36 extend outwards upon rotation of spindle 12.

The arrangement of the bearing support 14 in the present invention provides wobble-free rotation of the spindle 12 of the motorized telescoping mechanism 10. Surprisingly, despite the fact that the bearing support 14 and bearing 33 do not move together with the telescoping segments 36, as in the prior art telescoping pole saw, and the spindle 12 is not journaled at all by the bearings of motor 18 as in the prior art telescoping mechanism, the position of the bearing support 14 and bearing 33 being displaced away from the motor 18 has been found to be sufficient to provide sufficient bearing support to eliminate wobbling.

The present invention provides unique mechanical interactions between the motor 18, spindle 12, and bearing support 14 (and/or bearing 33, if used). As opposed to the prior art, the rotation of spindle 12 is not supported at all by any shaft or bearings located in motor 18. Thus, the rotational support of spindle 12 is independent of any component of motor 18.

Furthermore, as described above for one non-limiting embodiment of the invention, bearing support 14 provides rotational support of the coupling member 30 which transmits torque to spindle 12. Rotational support of the larger diameter of coupling member 30 as opposed to the smaller diameter of spindle 12 greatly reduces or eliminates any wobbling of spindle 12. The reason is for any shaft which is rotationally supported by a bearing at one end thereof, the portion of the shaft which is at the furthest distance from the bearing support has the greatest tendency to precess (that is, vibrate or wobble). Increasing the diameter of the portion of the shaft that is journaled in the bearing reduces and can even eliminate the vibration at the far end of the shaft.

What is claimed is:

1. A telescoping mechanism comprising:
a handle comprising a motor and a controller operatively connected to said motor for controlling operation of said motor;
a spindle operatively coupled to, and configured to be rotated by, said motor;
a bearing support distanced from said motor, said spindle not being journaled by said motor and instead being journaled by said bearing support; and
telescoping segments coupled to said spindle, wherein said telescoping segments are nested together in a contracted orientation and extend outwards upon rotation of said spindle.

2. The telescoping mechanism according to claim 1, wherein said bearing support is located an axial distance away from an end of a motor shaft of said motor.

3. The telescoping mechanism according to claim 1, wherein said bearing support comprises a plate formed with a bearing aperture with smooth surfaces to support rotation of said spindle, and sides that extend from said plate.

4. The telescoping mechanism according to claim 1, wherein said motor is coupled to said spindle via a gear train.

5. The telescoping mechanism according to claim 4, wherein said gear train meshes with a coupling member which is coupled to said spindle.

6. The telescoping mechanism according to claim 5, wherein said spindle is journaled by said bearing support by means of said coupling member being rotationally supported by said bearing support.

7. The telescoping mechanism according to claim 5, wherein said coupling member is formed with an aperture that couples with said spindle.

8. The telescoping mechanism according to claim 1, wherein said spindle is further journaled in a bearing located in said handle at an axial distance further away from said motor than said bearing support.

9. The telescoping mechanism according to claim 8, wherein said bearing is disposed in a recess formed in a lighting element.
